(19) United States
(12) Patent Application Publication
(10) Pub. No.: US 2025/0167729 A1
(43) Pub. Date: May 22, 2025

(54) METHOD AND SYSTEM FOR UTILIZING STATISTICAL OUTLIERS TO TEST FOR MALFUNCTIONING SOLAR PANEL SYSTEMS

(71) Applicants: Deep Chakraborty, Dublin, CA (US); Manasij Kar, BANGALORE (IN); Anika Misra, Los angeles, CA (US)

(72) Inventors: Deep Chakraborty, Dublin, CA (US); Manasij Kar, BANGALORE (IN); Anika Misra, Los angeles, CA (US)

(21) Appl. No.: 18/898,690

(22) Filed: Sep. 27, 2024

Related U.S. Application Data
(60) Provisional application No. 63/542,599, filed on Oct. 5, 2023.

(51) Int. Cl. H02S 50/00

(52) U.S. Cl. CPC H02S 50/00

(57) ABSTRACT

In one aspect, a computerized method for utilizing statistical outliers to test for malfunctioning solar panel systems comprising: identifying a plurality malfunctioning solar panels in a solar panel management system; enabling an active monitoring mode of the plurality malfunctioning solar panels that notifies the solar panel management system of a malfunctioning system in the plurality malfunctioning solar panels; calculating an estimated solar generation data for each individual customer; and providing a set of further security and information in regard to whether plurality malfunctioning solar panels in a solar panel management system has malfunctioned.

### CLAIM OF PRIORITY

This application claims priority to U.S. Provisional Patent Application No. 63/542,599, filed on Oct. 5, 2023 and titled METHOD AND SYSTEM FOR UTILIZING STATISTICAL OUTLIERS TO TEST FOR MALFUNCTIONING SOLAR PANEL SYSTEMS. This provisional patent application is hereby incorporated by reference in its entirety.

### BACKGROUND

As of now, companies that manage solar panel systems for homeowners and commercial properties can only reactively determine when the system is “online” and when it is “offline”. An offline status is usually provided when the inverter is not receiving any generation data, whether it be through a connectivity issue or an API issue. An online status is when generation data is being received. However, there is no way to proactively determine if the system is about to go offline. What this process does is predict if this solar panel system will go offline-hence producing a new state: “Unhealthy”, or, “Warning”.

### BRIEF SUMMARY OF THE INVENTION

In one aspect, a computerized method for utilizing statistical outliers to test for malfunctioning solar panel systems comprising: identifying a plurality malfunctioning solar panels in a solar panel management system; enabling an active monitoring mode of the plurality malfunctioning solar panels that notifies the solar panel management system of a malfunctioning system in the plurality malfunctioning solar panels; calculating an estimated solar generation data for each individual customer; and providing a set of further security and information in regard to whether plurality malfunctioning solar panels in a solar panel management system has malfunctioned.

In another aspect, a computerized method for utilizing a statistical outlier to test for malfunctioning solar panel system comprising: providing a plurality malfunctioning solar panels in a solar panel management system; enabling an active monitoring mode of the plurality malfunctioning solar panels that notifies the solar panel management system of a malfunctioning system in the plurality malfunctioning solar panels; for the plurality malfunctioning solar panels in a solar panel management system, collecting a set of estimated solar generation data and actual solar generation data for a specific time interval; calculating an accuracy ratio for the time interval to generate an accuracy ratio entry; for the accuracy ratio entry, determining if the accuracy ratio entry is an outlier in the set of accuracy ratios that were previously generated for another set of two or more time intervals for the plurality malfunctioning solar panels in the solar panel management system; detecting that an accuracy ratio entry is a statistical outlier; and flagging the time interval of the accuracy ratio, wherein the flagged time interval indicates that the time interval is abnormally low or abnormally high . . .

### BRIEF DESCRIPTION OF THE DRAWINGS

FIG. 1 illustrates an example process for utilizing statistical outliers to test for malfunctioning solar panel systems, according to some embodiments.

FIG. 2 illustrates another example process for utilizing statistical outliers to test for malfunctioning solar panel systems, according to some embodiments.

The Figures described above are a representative set and are not an exhaustive with respect to embodying the invention.

### DESCRIPTION

Disclosed are a system, method, and article of manufacture of utilizing statistical outliers to test for malfunctioning solar panel systems. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Actual generation entry can be the amount of actual energy generation associated with one specific time interval.

Accuracy ratio can be for the same time interval, the ratio created by dividing the estimated energy generation by the actual energy generation. OR, for the same time interval, the ratio created by dividing the actual energy generation by the estimated energy generation.

Accuracy ratio entry can be an accuracy ratio associated with the same specific time interval that the estimated generation entry and actual generation entry used in the ratio's calculation were also associated with.

Estimated generation entry can be the amount of estimated energy generation associated with one specific time interval.

Outlier can be any data point that is “abnormally far” from the rest of the data points. In some examples, this means +3 or −3 standard deviations away from the mean.

Solar power is the conversion of energy from sunlight into electricity, either directly using photovoltaics (PV) or indirectly using concentrated solar power. Photovoltaic cells convert light into an electric current using the photovoltaic effect. Solar power plants use one of two technologies: Photovoltaic (PV) systems use solar panels, either on rooftops or in ground-mounted solar farms, converting sunlight directly into electric power. Concentrated solar power (CSP) uses mirrors or lenses to concentrate sunlight to extreme heat to eventually make steam, which is converted into electricity by a turbine. A solar tracker is a device that orients a payload toward the Sun. Payloads can be, inter alia: solar panels, parabolic troughs, fresnel reflectors, lenses, or the mirrors of a heliostat.

Time interval can be a consistent time period where solar panel energy generation is measured such as a month, a day, a week, etc. (e.g. months can be effective, etc.).

### Example Methods of Utilizing Statistical Outliers to Test for Malfunctioning Solar Panel Systems

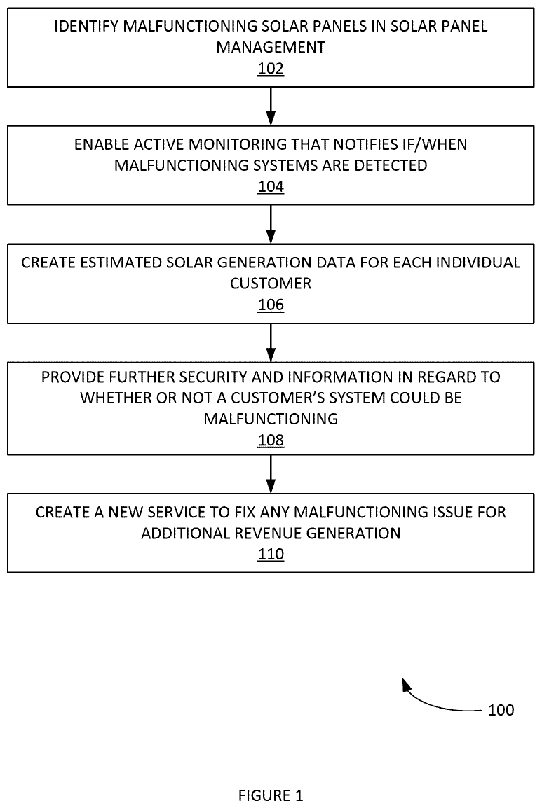

FIG. 1 illustrates an example process 100 for utilizing statistical outliers to test for malfunctioning solar panel systems, according to some embodiments. Process 100 uses a unique and advantageous process that uses statistical outlier testing to notify a customer if their system is malfunctioning.

In step 102, process 100 can identify malfunctioning solar panels in solar panel management. Process 100 can help systems that have an inverter type that is not supported by Enact Systems. In step 104, process 100 can enable active monitoring that notifies if/when malfunctioning systems are detected.

Process 100 can be used to attract new customers that may already have solar panel systems installed. In step 106, process 100 can create estimated solar generation data for each individual customer. Leveraging these estimations, process 100 can take past generation insights and notify potential new customers using my outlier testing technique if their solar system has been offline in the past.

Even if an active monitoring system exists for a customer, in step 108, process 100 can provide further security and information in regard to whether or not a customer's system could be malfunctioning. This useful insight of malfunctioning solar panel systems can further be monetized or added as a feature of solar scorecards.

Optionally, in step 110, process 100 can create a new service to fix any malfunctioning issue for additional revenue generation. For example, create a service provider network to fix an issue as soon as the customer sees the report.

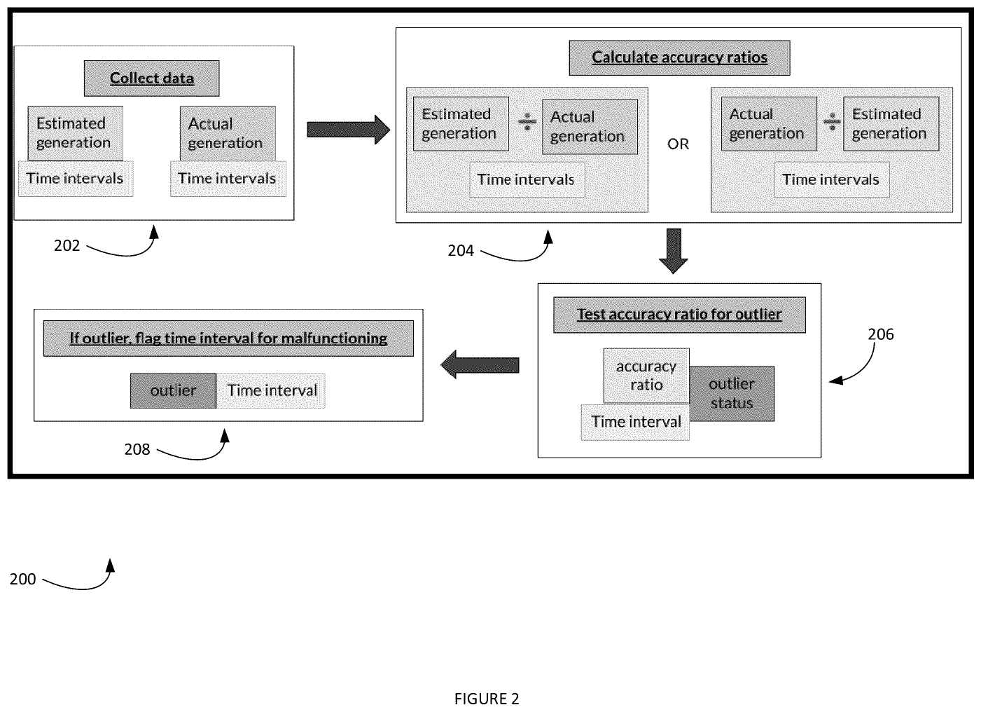

FIG. 2 illustrates another example process for utilizing statistical outliers to test for malfunctioning solar panel systems, according to some embodiments.

In step 202, process 200 can collect estimated solar generation data and actual solar generation data for two or more specific time intervals. In step 204, process 200 can calculate each accuracy ratio for every time interval. For every accuracy ratio entry, in step 206, process 200 can test to see if it is an outlier in the set of all accuracy ratios.

If an accuracy ratio entry is an outlier, then process 200 can flag the time interval that this accuracy ratio is associated with in step 208. This flagged time interval can enable process 200 to understand that generation for a particular time interval is abnormally low or high. In step 210, process 200 can then proceed to notify the customer or further investigate.

It is noted that by comparing actual generation data to estimated generation data, process 200 can create an accuracy ratio that tells us how far away the actual generation is from what was expected. Then, by using statistical outlier testing, process 200 can flag offline systems.

Example methods of detecting statistical outliers are now discussed. Statistical tests and methods for detecting outliers include, inter alia: Z-score: Converts data points into z scores to identify extreme values; IQR (Interquartile Range): Defines outliers based on data distribution; Modified Z-score: Another mathematical method to detect outliers; Probabilistic and statistical models: Leverage probability distributions to identify unlikely observations; etc.

As used herein, in some embodiments, the accuracy ratio (AR) can be a measure of a model's strength. The accuracy ratio can be defined as a ratio of an area between the model cumulative accuracy profile (CAP) and a random CAP. In an effective model, the AR has values can be between zero and one, and the higher the value is, then it indicates a stronger model. When the accuracy ratio is less than 4:1 (by way of example), then a calibration tolerance can be reduced to compensate. In some examples, the AR can be a summary quantitative measure of the Discriminatory Power in classification models. The AR measure can express the ratio of the area above and under the power curve (also cumulative accuracy profile (CAP)) of the model under consideration versus a perfectly discriminating model. The AR can be denoted as the Gini Coefficient.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method for utilizing statistical outliers to test for malfunctioning solar panel systems comprising:
identifying a plurality malfunctioning solar panels in a solar panel management system;
enabling an active monitoring mode of the plurality malfunctioning solar panels that notifies the solar panel management system of a malfunctioning system in the plurality malfunctioning solar panels;
calculating an estimated solar generation data for each individual customer; and
providing a set of further security and information in regard to whether plurality malfunctioning solar panels in a solar panel management system has malfunctioned.

2. The computerized method of claim 1, wherein the solar panel management system comprises an inverter type solar panel management system.

3. The computerized method of claim 2, wherein the step of calculating an estimated solar generation data for each individual customer leverages a plurality of past generation insights for each individual customer.

4. The computerized method of claim 3, wherein the step of calculating an estimated solar generation data for each individual customer further comprises:
notifying at least one potential new customer using a specified outlier testing technique when the plurality malfunctioning solar panels in a solar panel management system has been offline at some point.

5. The computerized method of claim 4 further comprising:
detecting the malfunctioning system in the plurality malfunctioning solar panels.

6. The computerized method of claim 5 further comprising:
creating a new service to fix the malfunctioning issue for additional revenue generation.

7. The computerized method of claim 6 further comprising:
creating a service provider network to fix an issue as soon as the customer receives the new service to fix.

8. A computerized method for utilizing a statistical outlier to test for malfunctioning solar panel system comprising:
providing a plurality malfunctioning solar panels in a solar panel management system;
enabling an active monitoring mode of the plurality malfunctioning solar panels that notifies the solar panel management system of a malfunctioning system in the plurality malfunctioning solar panels;
for the plurality malfunctioning solar panels in a solar panel management system, collecting a set of estimated solar generation data and actual solar generation data for a specific time interval;
calculating an accuracy ratio for the time interval to generate an accuracy ratio entry;
for the accuracy ratio entry, determining if the accuracy ratio entry is an outlier in the set of accuracy ratios that were previously generated for another set of two or more time intervals for the plurality malfunctioning solar panels in the solar panel management system;
detecting that an accuracy ratio entry is a statistical outlier; and
flagging the time interval of the accuracy ratio, wherein the flagged time interval indicates that the time interval is abnormally low or abnormally high.
